(19) United States
(12) Patent Application Publication
(10) Pub. No.: US 2008/0057181 A1
(43) Pub. Date: Mar. 6, 2008

(54) Resin Layer Forming Method And Apparatus For The Same

(75) Inventors: Hideo Kobayashi, Tokyo (JP); Takayuki Suzuki, Yachiyo-shi (JP); Naoto Ozawa, Tokyo (JP)

Correspondence Address: WOOD, HERRON & EVANS, LLP, 2700 CAREW TOWER, 441 VINE STREET, CINCINNATI, OH, 45202, US

(73) Assignee: ORIGIN ELECTRIC COMPANY, LIMITED, Tokyo (JP)

(21) Appl. No.: 11/575,107

(22) PCT Filed: Sep. 14, 2004
(86) PCT No.: PCT/JP04/13377

§ 371 Date: Mar. 12, 2007

(51) Int. Cl. B05C 11/10

(52) U.S. Cl. 427/9; 118/696; 427/240

(57) ABSTRACT

With respect to a liquid material such as an adhesive supplied at an inside portion between substrates, or the liquid material supplied to the inside portion on a substrate, a step of extending by rotation at a high speed and a step of rotating at a low speed are repeatedly and alternately conducted, and radiation of light is continuously or intermittently moved in order to gradually semi-cure or cure the liquid material in a radial direction from inside to outside. Therefore, the thickness of a resin layer made from the liquid material is gradually fixed in a radial direction from inside to outside.

### BACKGROUND OF THE INVENTION

1. Field of the Invention

The present invention relates to a resin layer forming method and an apparatus for the same which are appropriate for forming a resin layer of a substantially uniform thickness between or on substrates such as optical disc substrates of DVDs.

2. Description of Related Art

In general terms, an optical disk such as a DVD has a constitution in which two transparent substrates are adhered by an adhesive. With respect to the substrates, there is a case in which a recording layer includes a reflective layer or a diffusion shell is formed only on one substrate, and there is a case in which the recording layers are formed on both substrates. When the recording layer is formed only on one substrate, there is a case in which both substrates are equal in thickness, and moreover, there is a case in which one of the substrates on which the recording layer is not formed has a thin transparent sheet as a transparent protective coating. Moreover, there is a case in which a pair of objects which have a structure of adhering two substrates are adhered by using an adhesive; therefore, it has a layered structure including four substrates in total. Furthermore, there is a case in which multiple transparent glass and lenses are adhered by using an adhesive.

When such adhered, layered or laminated type discs are produced, especially in a case of optical discs such as DVDs, operations are generally conducted which include: after putting two substrates together so as to be overlapped along with putting the adhesive in between, rotating at a high speed in order to uniformly extend the adhesive between the substrates and to shake off the excessive adhesive; and after that, an ultraviolet ray is radiated from one or both sides of the substrates in order to harden or cure the adhesive in a short time. With respect to the radiation of an ultraviolet ray, the ultraviolet ray is continuously radiated for a certain length of time by using a UV lamp, or is radiated in a manner like a pulse by using a xenon lamp.

However, in such methods of using the lamps, there is a tendency in which the adhesive is unevenly distributed so as to be on an outside edge because of the centrifugal force caused by the high speed rotation; therefore, the adhesive is not evenly spread in substance. As shown by the curves A and B in FIG. 20, there is a problem in which the adhesive is spread with a larger thickness on the outside edge than on an inside edge. The curve A shows a layer thickness characteristic in a case of rotating the substrates at a rotation of 3,000 rpm for 13 seconds, and the curve B shows a layer thickness characteristic in a case of rotating the substrates at a rotation of 3,000 rpm for 20 seconds.

In both cases of the curves A and B, a maximum difference in thickness of the adhesive layer is approximately 8 μm; however, this has been a problem for improving the quality of DVDs today. This is because an error is caused when disc information is optically read. As shown by the curves A and B in FIG. 20, if the layer thickness of the inside edge is adjusted so as to be a predetermined value, the layer thickness of the outside edge is larger; however, if the layer thickness of the outside edge is adjusted so as to be a predetermined value, the layer thickness of the inside edge is smaller. In other words, it is not possible to adjust the layer thickness so as to be even by changing or tuning the rotation time or the rotation speed.

Especially, with respect to the next generation large volume optical discs which are called a Blu-ray Disc and an HDDVD (High-Definition DVD), uneven thickness of the adhesive layer is a big problem.

With respect to the Blu-ray Disc, a layer thickness of a transparent protective coating constituted from an adhesive layer and a sheet or a layer thickness of the transparent protective coating constituted from transparent resin is very thin, for example, 0.1 mm; therefore, if the thickness of the adhesive layer or the transparent resin layer is uneven, there is a significant influence, and the quality of the next generation large volume optical disc is greatly affected.

With respect to the HDDVD, both substrates which are adhered together have a thickness of 0.6 mm that is the same as a normal DVD; however, it is necessary to evenly adjust the layer thickness of the adhesive for adhering them with sufficiently with high accuracy. Therefore, either way, evenness of the layer thickness of the adhesive has a significant influence on quality of a next generation large volume optical disc.

### SUMMARY OF THE INVENTION

The present invention was conceived in order to solve the above-described problem, and has an object to evenly adjust the layer thickness of liquid material spread on the overall surface of the substrate in a step of extending the liquid material on the substrate by rotation at a high speed.

A first aspect is a resin layer forming method which is characterized by including: a step of supplying liquid material at an inside edge portion of a substrate; a step of alternately conducting both a step of extending the liquid material by rotating the substrate at a high speed and a step of rotating the substrate at a low speed which is lower than the high speed; a step of radiating during rotation at a low speed by gradually or intermittently moving the radiation area radially outward and semi-curing or curing the liquid material on the substrate radially outward with respect to the center.

In accordance with this resin layer forming method, in a step of extending the liquid material by rotation at a high speed, portions which have approximately a predetermined thickness are cured or semi-cured one by one and their thicknesses are fixed; therefore, it is possible to achieve even or uniform thickness of the liquid material spread on the overall surface of the substrate.

Moreover, the liquid material is extended upon rotation at a high speed and light is radiated when the liquid material is not substantially extended; therefore, the portions which have approximately a predetermined thickness are cured or semi-cured one by one and their thicknesses are fixed. Therefore, it is possible to achieve even or uniform thickness of the layer, it is possible to apply a light emitting unit which radiates smaller emission energy, and it is possible to reduce thermal influence on the substrate. In addition, compared to a constitution in which light is radiated on the adhesive which is flowing in order to spread, an effect of curing or semi-curing is stable, there is less irregularity or non-uniformity, and furthermore, there is an advantage in which it is easy to reuse the adhesive which is shaken off from the substrate because the adhesive which starts to be cured is not shaken off from the substrate.

It is preferable that the rotation at a low speed be performed for a length of time sufficient for semi-curing or curing the liquid material. In this case, it is possible to cure or semi-cure the resin layer of a portion which needs to be radiated in a short time, and it is possible to reduce the thermal influence on the substrate so as to be minimal.

It is preferable that the low speed be a speed which causes a centrifugal force that does not substantially extend the liquid material.

In this case, the resin layer is not extended upon rotation at a low speed; therefore, it is possible to further uniformly form the resin layer.

The liquid material can be an adhesive which is supplied between clear first and second substrates. The liquid material can be constituted from a clear synthetic resinous material and can form a light transmission protective layer of approximately uniform thickness.

Radiation can be continuously or intermediately conducted on portions which have a predetermined thickness because of being extended by rotation at a high speed, in order to fix the predetermined thickness from inside one by one.

In accordance with to this method, in a step in which the liquid material is extended by rotating at a high speed, portions of an approximately predetermined thickness are cured or semi-cured one by one; therefore, it is possible to stably and uniformly arrange the layer thickness of the liquid material on the overall surface of the substrate.

Data can be obtained beforehand based on parameters of at least both rotation speeds and characteristics including viscosity of the liquid material in order to set the liquid material to a predetermined thickness, and a radiation timing can be determined based on the data in order to form the resin layer of approximately uniform thickness.

In this case, portions which have an approximately predetermined thickness of the liquid material are automatically cured or semi-cured one by one and the thickness is fixed; therefore, it is possible to uniformly arrange the layer thickness of the liquid material on the overall surface of the substrate.

In the step of extending the liquid material by rotating the substrate at a high speed, the thickness of the liquid material which is extended can be detected, and the radiation can be conducted on a portion which has a predetermined thickness when the portion reaches the predetermined thickness.

In this case, portions which have an approximately predetermined thickness of the liquid material are cured or semi-cured one by one and the thickness is fixed; therefore, it is possible to uniformly arrange the layer thickness of the liquid material on the overall surface of the substrate.

A step can be further included in which the radiation is conducted on an overall surface of the resin layer after forming the resin layer from the liquid material. In this case, it is possible to completely cure the liquid material of the uniform thickness on the overall surface of the substrate.

A resin layer forming apparatus includes: a spinner which extends liquid material supplied to a substrate by rotation at a high speed; a rotation control apparatus which controls the rotation speed of the spinner; and a selective radiation unit which gradually moves the radiation position radially outward while the liquid material is extended by the spinner, wherein: the rotation of the spinner is alternately and repeatedly conducted at a high speed and a low speed; the radiation is conducted upon rotation at a low speed; and the liquid material is semi-cured or cured from inside.

In accordance with this resin layer forming apparatus, in a step of extending the liquid material by rotation at a high speed, portions which have approximately predetermined thicknesses are cured or semi-cured one by one and their thickness is fixed; therefore, it is possible to arrange the layer thickness of the liquid material with sufficient uniformity on the overall surface of the substrate.

Moreover, the liquid material is extended upon rotation at a high speed. Portions which have an approximately predetermined thickness are cured or semi-cured one by one or gradually and their thickness is fixed by radiating light when the liquid material is not substantially extended. Therefore, it is possible to achieve even or uniform thickness of the layer, it is possible to apply a light emitting unit which radiates lower emission energy, and it is possible to reduce thermal influence on the substrate.

The selective radiation unit can include: an emission unit; and a mechanical shutter which continuously or intermittently opens a center aperture, wherein a radiated area on the substrate radiated by the emission unit can be extended while opening the center aperture. In such a case, portions on which the liquid material has an approximately predetermined thickness are cured or semi-cured one by one, and their thickness is fixed; therefore, it is possible to provide an apparatus which can form the layer of the liquid material of uniform thickness on the overall surface of the substrate.

The selective radiation unit, in order to form the resin layer of approximately uniform thickness, can be an emission lamp which can include a plurality of semiconductor emission devices concentrically arranged on a plurality of rings; and the semiconductor emission devices continuously and gradually radiate from inside to outside. In such a case, it is possible to partially cure the adhesive radially outward from the center of the substrate one by one or gradually which is extended radially outward from the center of the substrate. Moreover, by applying a semiconductor light emission device as the light emitting unit such as a light emission diode, there is not a thermal influence on the substrate, it has a long life, and there is a significant effect on the cost.

The selective radiation unit can be an emission unit which is arranged at a position facing the center aperture of the substrate and which moves in a substantially vertical direction against a surface of the substrate; and the selective radiation unit can move away from the substrate while the liquid material is extended by rotating the substrate.

In this case, if an ultraviolet ray radiation apparatus is applied as the light emission unit, it is possible to omit a mechanical shutter; therefore, there is a significant effect on the cost, and moreover, it is possible to design the apparatus smaller.

The selective radiation unit can be an emission unit which radiates in a spot shape; and the selective radiation unit can move the spot from inside to outside on the substrate while the liquid material is extended by rotating the substrate.

In this case, it is possible to radiate light in a spot shape; therefore, it is possible to partially cure the adhesive radially outward from the center one by one or gradually which is extended radially outward from the center. Moreover, it is possible to omit a mechanical shutter for adjusting radiation light; therefore, there is a significant effect on the cost, and moreover, it is possible to design the apparatus smaller.

A resin layer forming apparatus can include: a spinner which extends liquid material supplied to a substrate by rotation at a high speed; a rotation control apparatus which controls the rotation speed of the spinner; and a radiation unit which gradually moves radiation position radially outward from the center while the liquid material is extended by the spinner, wherein: the rotation of the spinner can be alternately and repeatedly conducted at a high speed and a low speed; the radiation can be conducted upon rotating at the low speed; and the liquid material can be semi-cured or cured radially outward.

In accordance with this apparatus, in a step of extending the liquid material by rotation at a high speed, portions which have an approximately predetermined thickness are cured or semi-cured one by one and their thickness is fixed; therefore, it is possible to arrange the layer thickness of the liquid material with sufficient uniformity on the overall surface of the substrate.

Moreover, the liquid material is extended upon rotation at a high speed, portions which have an approximately predetermined thickness are cured or semi-cured one by one and their thickness is fixed by radiating light when the liquid material is not substantially extended. Therefore, it is possible to achieve even or uniform thickness of the layer, it is possible to apply a light emitting unit which radiates a smaller emission energy, and it is possible to reduce thermal influence on the substrate.

In accordance with the present invention, in a step of extending the liquid material by rotating at a high speed, portions which have an approximately predetermined thickness are cured or semi-cured one by one and their thickness is fixed; therefore, it is possible to uniformly arrange the layer thickness of the liquid material on the overall surface of the substrate.

### BRIEF DESCRIPTION OF THE DRAWINGS

FIG. 1 is a sectional drawing which shows a step of putting two substrates of an optical disc together so as to be overlapped by using an adhesive in between.

FIG. 2 is a sectional drawing which shows a first embodiment of a resin layer forming method and an apparatus for the same.

FIG. 3 is a sectional drawing which shows a state in which a shutter is open in the first embodiment.

FIG. 4 is a graph which shows rotation speed and timings of light emission.

FIG. 5 is a plane figure which shows an emission area of light on a disc.

FIG. 6 is a plane figure which shows a shutter of a second embodiment of a resin layer forming method and an apparatus for the same.

FIG. 7 is a sectional drawing which shows a state in which a shutter is closed.

FIG. 8 is a sectional drawing which shows a state in which a shutter is open.

FIG. 9 is a sectional drawing which shows another embodiment of a resin layer forming method and an apparatus for the same.

FIG. 10 is a sectional drawing which shows another embodiment of a resin layer forming method and an apparatus for the same.

FIG. 11 is a plane figure showing an arrangement of light emission diodes.

FIG. 12 is a sectional drawing of a light emission mechanism.

FIG. 13 is a graph for explaining an example of a rotation control of a disc.

FIG. 14 is a front view which shows another embodiment of a resin layer forming method and an apparatus for the same.

FIG. 15 is a graph for explaining another example of a rotation control of a disc.

FIG. 16 is a sectional drawing which shows a light emission apparatus of another embodiment of a resin layer forming method and an apparatus for the same.

FIG. 17 is a plane figure showing a movement of a light emission position.

FIG. 18 is a sectional drawing showing a movement of a light emission position.

FIG. 19 is a graph which shows results of the embodiments.

FIG. 20 is a graph which shows results of the embodiments.

FIG. 21 is a sectional drawing which shows a state of putting a liquid material on a cap in another embodiment.

FIG. 22 is a sectional drawing which shows a step of radiating light while extending a liquid material.

FIG. 23 is a sectional drawing which shows a step of curing a liquid material after extending.

FIG. 24 is a sectional drawing which shows a step of placing drops of an adhesive on a resin layer after forming.

FIG. 25 is a sectional drawing which shows a step of extending a drop of adhesive on which a disc is mounted.

### DETAILED DESCRIPTION OF THE INVENTION

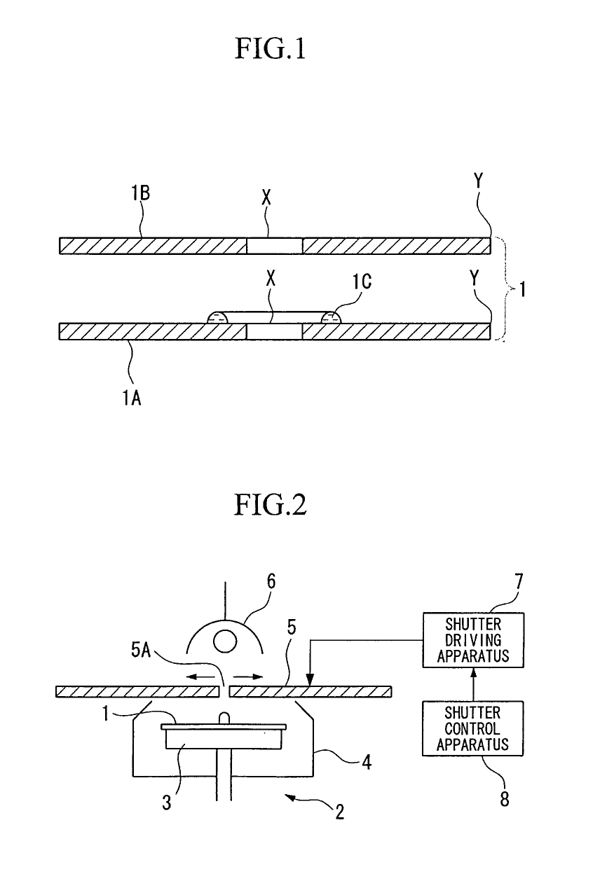

First, a basic concept of the present invention is explained. FIG. 1 shows two substrates 1A and 1B (made from, for example, polycarbonate) which are arranged so as to be facing each other before putting them together, and an adhesive 1C is supplied as a liquid material on the substrate 1A in a circular state. When the substrates 1A and 1B are adhered and overlapped, the position of the adhesive is pushed and extended; however, the position is generally not changed from the position at which the adhesive was supplied. Next, when a high speed rotation of the adhered disc is started, the adhesive 1C is extended because of centrifugal force.

In a step of moving the adhesive 1C radially outward by a high speed rotation, when the adhesive layer is a desired thickness, the adhesive layer is cured or semi-cured by radiating light from inside to outside. Therefore, if it is possible to prevent the adhesive layer from moving radially outward because of centrifugal force caused by the subsequent high speed rotation, the resin layer can be formed in an approximately uniform thickness. Not only in a case of adhering two substrates, but also in a case of forming the resin layer of the liquid material on one substrate, it can be applied in the same manner. A curve C of FIG. 12 shows an example of a layer thickness characteristic in a case of applying the present invention.

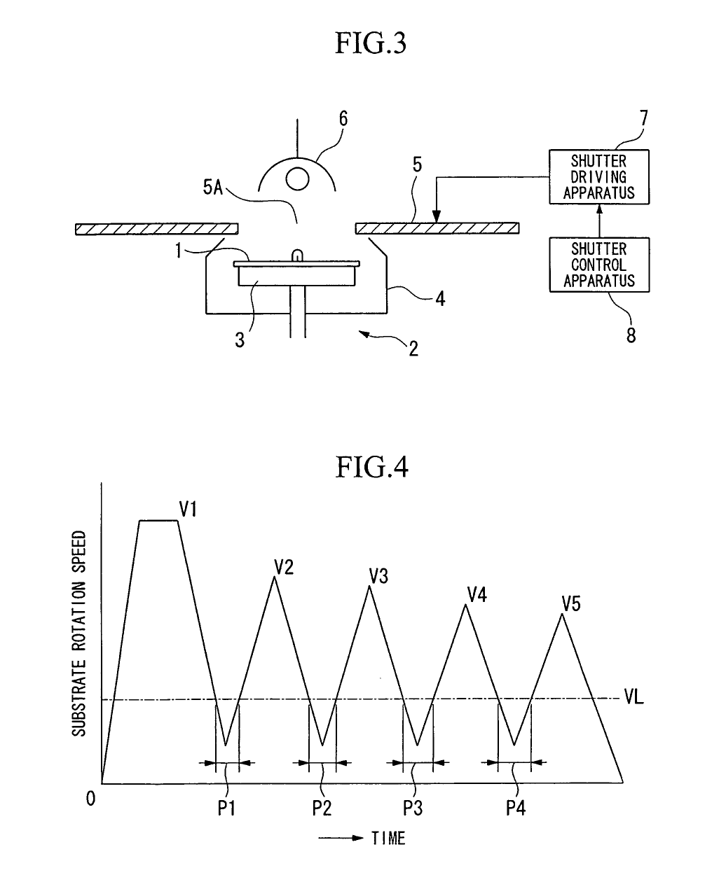

Hereinafter, referring to figures, an embodiment is concretely explained. FIGS. 2 and 3 show a first embodiment in which an optical disc is adhered by using a mechanical shutter and a light emission lamp. FIG. 2 shows an initial state in which a radiation aperture of the mechanical shutter is small, and FIG. 3 shows a state in which the radiation aperture of the mechanical shutter is opened to be maximal.

The substrate 1 is a substrate in which a substrate 1A and a substrate 1B are laminated or layered (see FIG. 1). The substrates 1A and 1B have a center aperture X, the vicinity of the center aperture is hereinafter referred as the inside, and the vicinity of the outside edge is hereinafter referred as the outside. In a case in which the recording layer including the reflection layer is formed on only one of the substrates, the recording layer is not formed on the substrate 1B, and the recording layer including the reflection layer is formed on the substrate 1A. In a case in which the recording layers are formed on both substrates, the recording layer including the diffusion shell is formed on the substrate 1B, and the recording layer including the reflection layer is formed on the substrate 1A. Both substrates 1A and 1B after supplying the adhesive 1C are adhered so as to be overlapped, the substrate 1 is obtained, and after that, the substrate 1 is mounted on the substrate receiving base 3 of the spinner 2 along with arranging a side of the substrate 1B upward with respect to the substrate 1A. The spinner 2 is conventionally used in the prior art and is normal, and it is possible to rotate the substrate receiving base 3 at a high speed up to a few thousand rpm.

Close from the coater house 4 of the spinner 2 and upward therefrom, the mechanical shutter 5 is horizontally arranged, and above that, a radiation lamp such as a discharge lamp or a xenon lamp is provided. The mechanical shutter 5 has a structure in which a radiation aperture 5A at the center is continuously or gradually opened. It is possible to apply a structure, such as the shutter of a camera, in which multiple metallic plates are arranged in a circular state so as to be partially overlapped, and the metallic plates are respectively moved continuously, gradually or intermittently at the same speed toward the outside in order to continuously or gradually extend a center aperture which is the radiation aperture 5A. The radiation aperture 5A continuously or gradually extends; therefore, a radiation area of an ultraviolet ray from the radiation lamp 6 continuously or gradually extends from inside to outside.

The mechanical shutter 5 is driven by a shutter driving apparatus 7, such as a small cylinder, which respectively moves the metallic plate forward or backward in a radial direction, and the shutter driving apparatus 7 is controlled in accordance with signals from a shutter control apparatus 8. The shutter control apparatus 8 has a CPU, and the like which are not shown in the figures, and its memory stores data beforehand which is obtained based on various experiments.

The data includes extending speeds of the adhesive corresponding to various conditions such as the rotation speed of the spinner 2, viscosity of the adhesive 1C which is used, characteristics such as wettability on the substrate, and temperature/humidity of the surrounding air, in other words, it includes relationship data between a position of the outside edge and time at which the adhesive 1C supplied in a circular state becomes a predetermined thickness. Based on this data, time after starting rotating at a high speed can be calculated that is when the adhesive layer at each point on a line in a radial direction is a predetermined thickness. Therefore, by inputting the above-described conditions to a CPU which is not shown in the figures, an optimized expansion or opening speed of the radiation aperture 5A of the mechanical shutter 5 is calculated. In this embodiment, a radiation lamp 6 is applied which is generally used in a field of producing the optical discs and which radiates a large amount of energy of the ultraviolet ray.

A characteristic of the concept of the embodiment is a point in which both a step of extending a liquid material C supplied on the inside edge portion of the substrate 1 by rotating at a high speed and a step of preventing the liquid material from extending by rotating the substrate 1 at a low speed are conducted alternately, and in which the radiation position of the ray is gradually or continuously moved from the inside edge portion to the outside edge portion of the substrate 1 upon rotating at the low speed, and the liquid material is gradually or continuously cured or semi-cured from the inside edge portion to the outside edge portion.

In accordance with such a constitution, compared to a constitution in which the ray is radiated on the adhesive upon flowing for extending, there is a more stable effect of curing or semi-curing, there is less uneven thickness and the like because there are less unevenly cured portions in a circumferential direction, and moreover, if a portion of the adhesive starts being cured or semi-cured, that portion is not shaken out of the substrate; therefore, there is an advantageous point in which it is easy to reuse the adhesive shaken out of the substrate.

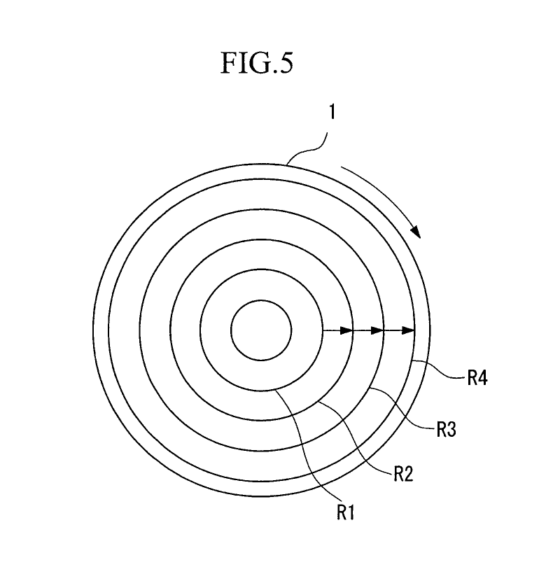

FIG. 4 is a graph which shows an example of a relationship among a rotation speed of the substrate 1, time after starting rotating and timings of light emission, and FIG. 5 is a plane figure which shows an emission area of light on the substrate 1. As shown in FIG. 1, the substrate 1 which is adhered so as to put the adhesive 1C in between is first, rotated at a first high rotation speed V1 for a predetermined time. At this time, the adhesive 1C which is arranged at the inside portion of the substrate 1 quickly reaches the outside edge portion, and the excess adhesive is shaken off of the outside edge of the substrate 1. The adhesive which is shaken off is received by the coater house 4.

Next, the substrate rotation speed is reduced so as to be a low rotation speed VL. The radiation lamp 6 is lit while the rotation speed is at the low rotation speed VL or lower or for a portion of a time span in which the rotation speed is at the low rotation speed VL or lower. The substrate rotation speed is increased after being maintained at a minimum for a predetermined time or immediately when it is at the minimum, and is increased so as to be a second high rotation speed V2. It is possible that following high rotation speeds V2-V5 are lower or slower than the first high rotation speed V1. This is because it is not necessary to shake off the excess adhesive anymore. When the substrate rotation speed reaches V2, and after being maintained at V2 for a predetermined time, it is reduced. Or, the substrate rotation speed is reduced immediately when it reaches V2. In other words, the high rotation speed and the low rotation speed are applied alternately as shown below.

0’→V1→lower than VL (radiate on R1)→V2→lower than VL (radiate on R2)→V3→lower than VL (radiate on R3)→V4→lower than VL (radiate on R4)→V5→0.

In this example, rotation at a high speed is conducted 5 times and radiation is conducted 4 times; however, this is not a limitation and it is possible to be appropriately changed based on an outside diameter of the substrate 1, and the like. In a case of a generally used optical disc, a preferable number of times of radiation is 2-6.

In this example, the radiation lamp 6 is lit when it is lower than VL except for just after starting rotation and just before stopping rotation. Radiation areas R1-R4 corresponding to the 1st to 4th radiation are, as shown in FIG. 5, extended step-by-step. It is necessary to determine both moving distance between these radiation areas and radiation time based on obtained results of experiments beforehand which include both points with predetermined thickness of the adhesive along with extending the adhesive and radiation time for fixing the adhesive. Fixing of the adhesive is defined to be cured or semi-cured so as not to substantially proceed the extension even by rotating at the high speed.

For example, with respect to a substrate of a radius of 60 mm, the adhesive 1C is extended by rotating the substrate 1 at the high speed while the radiation aperture 5A of the mechanical shutter 5 is in a closed state. After that, the substrate 1 is rotated at the low speed, the radiation aperture 5A of the mechanical shutter 5 is opened until a position corresponding to a radius of 20 mm while radiating an ultraviolet ray, and the adhesive layer spread inside an area of the radius of 20 mm is cured or semi-cured. Next, radiation is stopped once, the substrate 1 is rotated at the high speed again, and the adhesive 1C outside the radius of 20 mm is further extended. After that, the substrate 1 is rotated at the low speed, the radiation aperture 5A of the mechanical shutter 5 is opened until a position corresponding to a radius of 30 mm along with radiating an ultraviolet ray, and the adhesive layer is cured or semi-cured. In such a manner, the high speed rotation and the low speed rotation are repeated alternately, and at positions including the radius of 20 mm, 30 mm and 45 mm, the ultraviolet ray is radiated while rotating at the low speed.

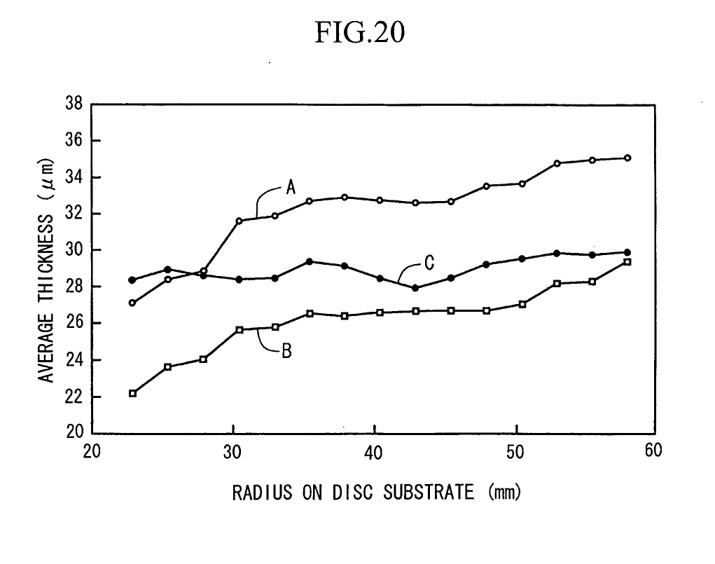

In accordance with such a manner, as shown by a curve C of FIG. 20, evenness of the adhesive layer is clearly improved, the maximum difference among layer thickness is smaller than approximately 2 μm, and this is ¼ of conventional cases. This is because centrifugal force of rotation applied on the adhesive 1C is reduced and the extension is prevented by rotating at a low speed, and the desired layer thickness is obtained. Moreover, it is possible to confirm that the adhesive at the radiation area which is cured or semi-cured does not move outside even by the centrifugal force of the high speed rotation afterward.

It should be noted that radiation of ultraviolet ray is conducted while rotating at a low speed; however, it is possible to radiate the ultraviolet ray while rotating at a high speed. In this case, it is possible to make the adhesive at the inside edge portion from a semi-cured state to a completely cured state. Moreover, it is possible to avoid continuously radiating while in the low speed rotation time P1-P4. It is possible to radiate at only a portion of time of the low speed rotation time, and it is possible to radiate in a non-continuous manner such as pulse.

The substrate rotation speed is not limited; however, in general, rotation speed at a high speed is adjusted in a range of 1,000-12,000 rpm. It is preferable that the low rotation speed VL upon radiating be approximately 100-600 rpm. It is possible to gradually reduce the highest speeds V2-V5. This is because the substrate rotation speed is smaller at the outside edge portion in order to generate the same centrifugal force. Moreover, it is possible that radiation time of the low speed rotation time P1-P4 be gradually longer. Because if the area which is radiated is moved radially outward, a density of light radiation energy is lowered.

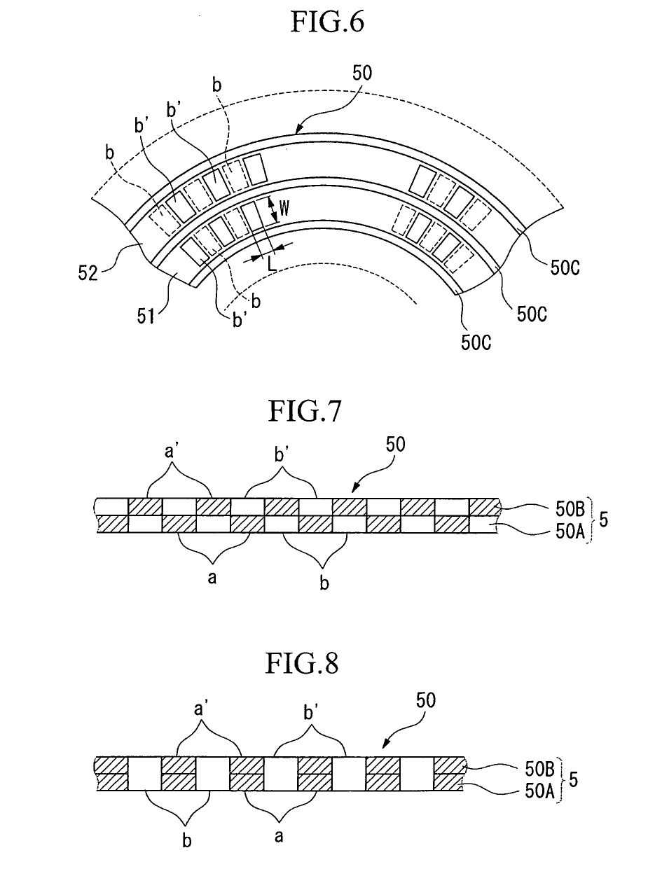

A second embodiment in which a mechanical shutter using another mechanism is explained in reference to FIGS. 6-8. FIG. 6 is a plane figure of a mechanical shutter 50 of this example. FIG. 7 shows a slit portion which constitutes a radiation aperture and which is in a closed state, and FIG. 8 shows the slit portion which constitutes the radiation aperture and which is in an opened state.

The mechanical shutter 50 of this embodiment includes both a fixed shutter member 50A in a circular shape positioned at a lower side and multiple movable ring-shape shutters 50B arranged above the fixed shutter member 50A. The fixed shutter member 50A has multiple ring-shape tracks constituting concentric circles, and a covered portion “a” without an aperture and a slit portion “b” with an aperture are alternately arranged on each of the tracks. The movable ring-shape shutter 50B is a metallic plate in a circular shape with a certain width which is rotatably arranged on each of the tracks of the fixed shutter member 50A. On the movable ring-shape shutters 50B corresponding to the covered portion a and the slit portion b of the track, a covered portion a′ and a slit portion b′ are alternately formed.

At positions which divide tracks 51, 52, . . . of the fixed shutter member 50A, a ring shape guide member 50C protruding upward is provided. The guide member 50C is movable along a circular direction and prevents the movable ring shape shutter member 50B from getting off track. There can be two or more tracks, and a number of tracks is preferably determined in a range less than 5 from a viewpoint of costs, and the like.

On each of the tracks with a certain width, the slit portions b in a rectangular shape with a circular direction length L and a radial direction width W are formed along with providing a certain interval or gap. There is the covered portion a between the neighboring slit portions b, and a gap or an interval between the two slit portions b, in other words, the length in a circular direction of the covered portion a is somewhat longer than the length L of the slit portion b in a circular direction.

On each of the tracks 51, 52 . . . of the fixed shutter member 50A with a certain width, a movable ring shape shutter member 50B is arranged so as to be overlapped which has the covered portion a′ and the slit portion b′ that are respectively as big as the covered portion a and the slit portion b. Each of the movable ring shape shutter members 50B is movable in a clockwise direction and a counterclockwise direction in accordance with the guide member 50C for the same distance as the slit portion b′.

In accordance with this mechanical shutter 50, by moving the movable ring shape shutter member 50B from inside track one by one, and by correspondingly arranging both the slit portion b and the slit portion b′, it is possible to continuously move a radiated area from inside to outside. A moving timing of the movable ring shape shutter member 50B is synchronized to a timing at which the adhesive which is extended because of centrifugal force is a predetermined thickness. However, in a practical case, there is a movement delay of the mechanical shutter 50 or the driving apparatus 7; therefore, the moving timing is determined in consideration of such things.

Movements or actions of the movable ring shape shutter 50B are controlled or driven by the shutter driving apparatus 7 and the shutter control apparatus 8 shown in FIGS. 2 and 3. The shutter driving apparatus 7 is constituted from a combination of a cam and a motor, multiple small cylinder apparatuses, or the like, and can open or close the radiation aperture by moving the movable ring shape shutter member 50B in a circular direction for approximately one slit. After opening the radiation aperture by correspondingly adjusting the slit portion b and the slit portion b′, it is possible to leave the movable ring shape shutter member 50B as it is, or it is possible to shut the radiation aperture after a predetermined time.

In accordance with this embodiment, the radiated area of the ultraviolet ray is not continuous along a radially outward direction on the substrate; however, portions on which the ultraviolet ray is radiated are cured or semi-cured, and therefore, the adhesive inside those positions is prevented from moving or flowing even though centrifugal force is applied. Moreover, in this embodiment, light radiation positions are not continuous along a circular direction; however, in order to prevent the adhesive from being unevenly cured, it is possible to adjust the lengths of the covered portion a and the slit portion b of the fixed shutter member 50A and the covered portion a′ and the slit portion b′ of the movable ring shape shutter member 50B so as to be smaller. Moreover, it is preferable that the covered portion a and the slit portion b of the fixed shutter member 50A be alternately arranged along a direction of the radius of the substrate because it is possible to prevent a portion of the adhesive layer on which the ultraviolet ray is not radiated from moving or flowing without problems.

In this embodiment, as shown in the above-described embodiment, the high speed rotation and the low speed rotation are alternately conducted, and the radiation aperture is continuously or gradually opened from the inside track to the outside track upon rotating at a low speed. In accordance with such an operation, it is possible to form the adhesive layer with uniform or even thickness as a whole.

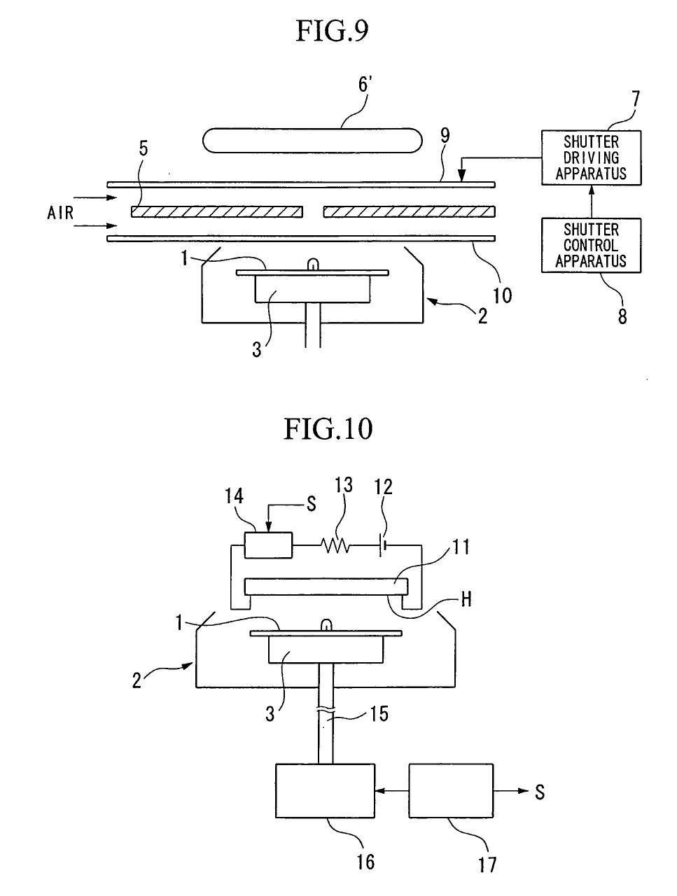

Next, in an embodiment shown in FIG. 9, a cooling mechanism to reduce the thermal effect on the substrate 1 and a wavelength selective filter 9 are provided in addition to the above-described mechanical shutter 5 (or 50). The wavelength selective filter 9 which blocks a certain wavelength such as infrared is arranged between a discharge lamp 6′ which can continuously generate an ultraviolet ray and the mechanical shutter 5. A heat-resistant glass 10 is provided between the mechanical shutter 5 and the spinner 2. These constitutional elements are arranged so as to form a wind tunnel surrounding the mechanical shutter 5, and are arranged so as to be opened in a direction of right and left of the figure and closed in a direction along front and back surfaces of the figure; therefore, cooling air flows from left to right as shown by an arrow in the figure.

If the mechanical shutter 5 is made from an aluminum plate which comparatively reflects light well, temperature of the mechanical shutter 5 largely increases while in a step of repeated operations; therefore, there is a possibility in which there is an undesirable influence on the operations of the mechanical shutter 5 and there is a possibility in which undesirable distortion or warping is caused or a large tilt is caused because of such large influence on the substrate 1. In accordance with such a constitution, in this embodiment, the wavelength selective filter 9 which blocks certain wavelengths such as infrared rays is applied as a constitutional element of the wind tunnel; therefore, infrared rays which cause heat are removed, the mechanical shutter 5 is effectively cooled down by effectively allowing the cooling air to flow, and at the same time the wavelength selective filter 9 is cooled down. Therefore, in this embodiment, it is possible to reduce the thermal effects on the substrate 1. It should be noted that, only for forming the wind tunnel, a heat-resistant glass plate can be applied to the wavelength selective filter 9. Operations or functions of the mechanical filter 5 are the same as the above-described embodiment; therefore, explanations are omitted.

Next, an embodiment of FIGS. 10-13 has characteristics in which a state of almost no thermal influence on the substrate is achieved because a light emission lamp is applied which is constituted from multiple light emission semiconductor devices such as light emission diodes or laser diodes arranged on multiple tracks constituting concentric circles.

Constitutional elements to which the same reference numerals as the above-described embodiment are assigned indicate similar elements or portions as the above-described embodiment. In this embodiment, as above, extending the adhesive by rotation at a high speed and stopping extension are repeated, and the extended adhesive is semi-cured by radiating light while stopping the extension, in other words, extending the adhesive in a radially outward direction from the inside or the center so as to be a predetermined thickness and semi-curing the adhesive are repeated. Here, the light is light having a wavelength which is effective for obtaining a curing reaction of the adhesive or a resin which are used.

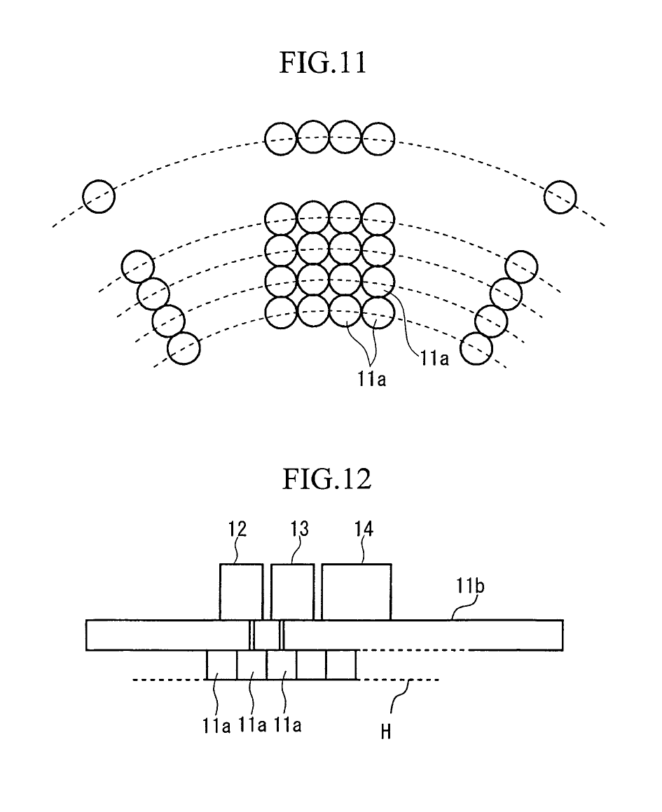

As shown in FIG. 10, a semiconductor light emission lamp 11 is arranged directly upon the substrate 1. As shown in FIG. 11, the semiconductor light emission lamp 11 is constituted from both multiple light emission diodes 11a which are light emission semiconductor devices and a supporting body 11b supporting these light emission diodes 11a. In this embodiment, the multiple light emission diodes 11a are closely arranged, and are attached to the supporting body 11b so as to be in a state in which light emission surfaces H of the light emission diodes 11a are on a same plane. It is preferable that the multiple light emission diodes 11a are arranged on concentric circles. Most of the light emission diodes 11a are omitted in the figures; however, if the light emission diodes 11a are provided on an overall surface along with arranging neighboring light emission diodes so as to be almost contacting, one light emission lamp is constituted from approximately 350-400 light emission diodes 11a. It is preferable that these light emission diodes 11a be parallel-connected. It is not necessary for the light emission diodes to be arranged so as to face the whole surface of the substrate 1, and it is possible to arrange the light emission diodes so as to be a portion of the whole circle, for example, a sector form of 120 degrees. Moreover, with respect to the neighboring light emission diodes in the radial direction, it is possible to arrange them with an interval or a gap, for example, it is possible that the light emission diodes arranged in a ring shape be provided with an interval or a gap between the rings.

As shown in FIG. 12, a cathode of each of the light emission diodes 11a is connected to a negative pole of a DC power supply 12, and an anode side of each of them is connected to a positive pole of the DC power supply 12 via a protective resistance 13 and a switching control apparatus 14. With respect to the switching control apparatus 14, in the simplest case, the circuit is opened and closed in a certain cycle; however, in some cases, a simple sequencer or a CPU is provided in order to connect or release the multiple light emission diodes one by one. The light emission surface of the light emission diodes 11a is arranged at a position at which an upper surface of the substrate does not touch; however, if a gap or an interval between the light emission surface H and the upper surface of the substrate 1 is as small as possible, greater effects can be obtained. This is because light decreases proportionally with respect to the square of the distance. It is possible that the interval or the gap between the light emission surface H and the substrate 1 be 10 mm or closer, and a range of 1-7 mm is preferable. The light emission diode used here is much smaller than the energy of the ultraviolet ray generated by a UV radiation lamp; therefore, it is effective to use one which generates light of the wavelength band of 280-600 nm for semi-curing the adhesive.

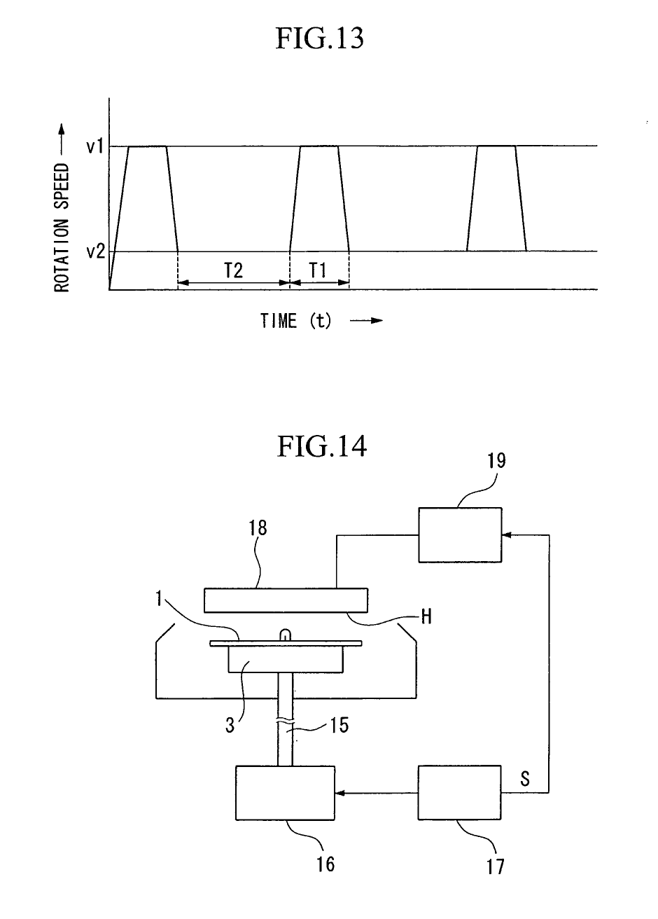

This apparatus provides a rotation driving apparatus 16 such as a motor which rotates the substrate receiving base 3 via a rotation shaft 15, and a rotation control apparatus 17 which controls the rotation driving apparatus 16. In this embodiment, as shown in FIG. 13, the substrate receiving base 3 is alternately and repeatedly rotated at a high speed and a low speed. It is possible that all high speed rotations be a certain rotation speed v1 of approximately 1,000-12,000 rpm. In this high speed rotation time T1, the adhesive is extended radially outward, and the extension is temporarily suspended and the adhesive is semi-cured in a low speed rotation time T2 in order to prevent further extension of the adhesive layer which has been already extended because of the high speed rotation afterward.

A rotation speed v2 of the low speed rotation time T2 is respectively a rotation speed which substantially does not cause further extension of the adhesive, and a concrete example is 100-600 rpm. In this embodiment, the low speed rotation time T2 is longer than the high speed rotation time T1 because the energy of the ultraviolet ray from the semiconductor light emission lamp 11 is weak and it takes a long time to semi-cure the adhesive layer. In concrete terms, in this embodiment, on a substrate of 60 mm radius, it is possible to radiate a ultraviolet ray with a few mm width respectively at positions of 20 mm, 30 mm and 45 mm on the circle.

It is possible to adjust the rotation speed, length of the rotation time T1 and T2, and the like by using the rotation control apparatus 17. Data of multiple rotation models (combinations of the high rotation speed v1, low rotation speed v2, time of them, and the like) which is obtained based on various experiments conducted beforehand, and which can be applied to characteristics including for example, viscosity of the adhesive, surrounding and environmental conditions, and the like, is stored in the rotation control apparatus 17. An operator selects the rotation model or inputs characteristics of the adhesive, and the data model appropriate to conditions is automatically selected. It should be noted that it is not necessary for the high rotation speeds of the positions or the low rotation speed of the positions to be the same, and it is possible to apply appropriate speed.

Next, operations of this embodiment are explained. First, the operator inputs necessary data such as viscosity of the adhesive to a CPU of the rotation control apparatus 17 which is not shown in the figures. This data is different in accordance with requested accuracy of the layer thickness. In accordance with this operation, an appropriate rotation model is selected inside the rotation control apparatus 17. Hereby, the rotation control apparatus 17 transmits a control signal to the rotation driving apparatus 16, the substrate receiving base 3 conducts the first high speed rotation because of the rotation driven by the rotation driving apparatus 16 in accordance with the selected rotation model, and the adhesive 1C is extended at an inside edge of the substrate 1. This high speed rotation time T1 is approximately the same as the time for arranging the thickness of the adhesive layer so as to be almost the predetermined thickness on the substrate surface facing the light emission diodes 11a arranged in a ring shape at the innermost side of the semiconductor light emission lamp 11.

Just after the time T1 at the same time of transiting to the first low rotation speed, or while rotating at a high speed, the switching control apparatus 14 acts and controls the light emission diodes 11a arranged in a ring shape at the innermost side of the semiconductor light emission lamp 11 to emit light. In a conventional case, the rotation control apparatus 17 transmits a signal S to the switching control apparatus 14 in order to activate just after or after the time T1 from transmitting a driving signal of the high speed rotation. Because of ultraviolet ray from the semiconductor light emission lamp 11, the adhesive layer substantially of predetermined thickness on the substrate surface facing the light emission diodes 11a is in a semi-cured state, and is not moved due to centrifugal force caused by the high speed rotation afterward.

Next, by transiting to a second high speed rotation, the adhesive is extended so as to be a predetermined thickness on a certain area. The area corresponds to an area on the substrate facing the light emission diodes 11a which are arranged on a secondary innermost side of the semiconductor light emission lamp 11 and which emit at second emission time, and the adhesive on the area of the substrate is semi-cured. Such the operation is repeated at a third time as well; therefore, the adhesive on a ring shape area of a certain width along a radially outward direction is extended so as to be a certain thickness and is semi-cured. The predetermined thickness is fixed and influence of centrifugal force due to the high speed rotation afterward is prevented. Therefore, the adhesive layer of an overall even thickness is formed.

It should be noted that, after starting emitting light from the semiconductor light emission lamp 11 arranged inside, it is preferable that the lamp emit light until the end of the adhering step of the substrate 1 in order to encourage or facilitate curing. This is because emission energy of the light emission diode is small and there is small thermal influence.

It is not shown in the figures; however, it is possible to apply a laser diode which generates an ultraviolet ray that has a wavelength range of 280-600 nm wavelength instead of the light emission diode. In such a case, cost increases; however, it is possible to shorten the low speed rotation time, and it is possible to shorten the time required for adhering the optical disc. In this case, it is sufficient to arrange one on the circle, or to arrange a few at certain regular intervals.

FIG. 14 shows an embodiment using a light emission member 18 to which plasma display technology is applied instead of the semiconductor light emission lamp of the above-described embodiment. The same reference numerals used in the above-described embodiment indicate similar members.

A plasma display panel has, as generally known, multiple electrodes set in accordance with a predetermined arrangement, and only the portion on which voltage is applied between the electrodes emits light. This embodiment uses such a function. However, an ultraviolet ray is used in this embodiment; therefore, a filter member for blocking ultraviolet ray, and the like are omitted, and it is constituted so as to easily generate the ultraviolet ray outward. Here, it is called a plasma unit which is constituted so as to easily generate the ultraviolet ray outward.

It is preferable that the light emission member 18 constituted from the plasma member be arranged so as to have an interval of approximately 1-7 mm, and as explained in the above-described embodiments, the radiation is gradually moved radially outward from the center in accordance with a radiation pattern control apparatus 19. At this time, the high speed rotation and the low speed rotation are alternately conducted. The rotation control is the same as the above-described embodiment.

Data of multiple radiation patterns (radiation width, radiation time, radiation suspension time, and the like) which is obtained based on various experiments conducted beforehand, and which can be applied to characteristics including for example, viscosity of the adhesive, and which is adaptable to surrounding and environmental conditions, are stored in the radiation pattern control apparatus 19. An operator selects the radiation pattern or inputs the characteristics of the adhesive and the radiation pattern appropriate to the conditions is automatically selected. It is possible that the radiation time and the radiation suspension time be set in accordance with the high rotation speed time T1 and the low rotation speed time T2 of the selected rotation model at the rotation control apparatus 17.

The radiation pattern control apparatus 19 receives the control signal S from the rotation control apparatus 17 at the same time or the high speed rotation time T1 later than the time when the rotation control apparatus 17 transmits a drive signal to the rotation driving apparatus 16 for requesting the first high speed rotation of the substrate receiving base 3 as shown in FIG. 13. After receiving the control signal S, the radiation pattern controls apparatus 19 controls pixels of the light emission member 18 positioned on a circular area at an innermost side so as to radiate in accordance with the radiation pattern for the first low speed rotation time T2 of the substrate receiving base 3. By receiving ultraviolet light from this radiation, the adhesive in a ring shape at the innermost side is semi-cured.

Next, when the second high speed rotation time starts, the radiation pattern control apparatus 19 controls the light emission member 18 so as to stop radiating, and when the second low speed rotation time T2 starts, the radiation pattern control apparatus 19 controls pixels of the light emission member 18 positioned on a circular area at a secondary innermost side (not shown in figures) so as to radiate in accordance with the radiation pattern. Thereafter, operations in such a manner are repeated, and the adhesive is semi-cured to the outermost side of the substrate 1. After that the substrate is transferred and mounted on another position not shown in the figures, and the ultraviolet ray is radiated overall in order to completely cure or harden. With respect to a portion of the light emission member 18 which has started emitting, it is preferable that the portion continue emitting until the end of the adhering step from a viewpoint of encouraging or facilitating curing. It should be noted that it is preferable to apply the light emission member 18 which has a constitution in which ring electrodes of different radius are arranged with a predetermined gap or interval.

As described above, the above-explained operation is repeated in this embodiment as well; therefore, the adhesive on the ring shape area of a certain width in a radial direction is extended so as to be a certain thickness and is semi-cured. The predetermined thickness is fixed and influence of centrifugal force because of the high speed rotation afterward is prevented. Therefore, the adhesive layer of an even thickness overall is formed.

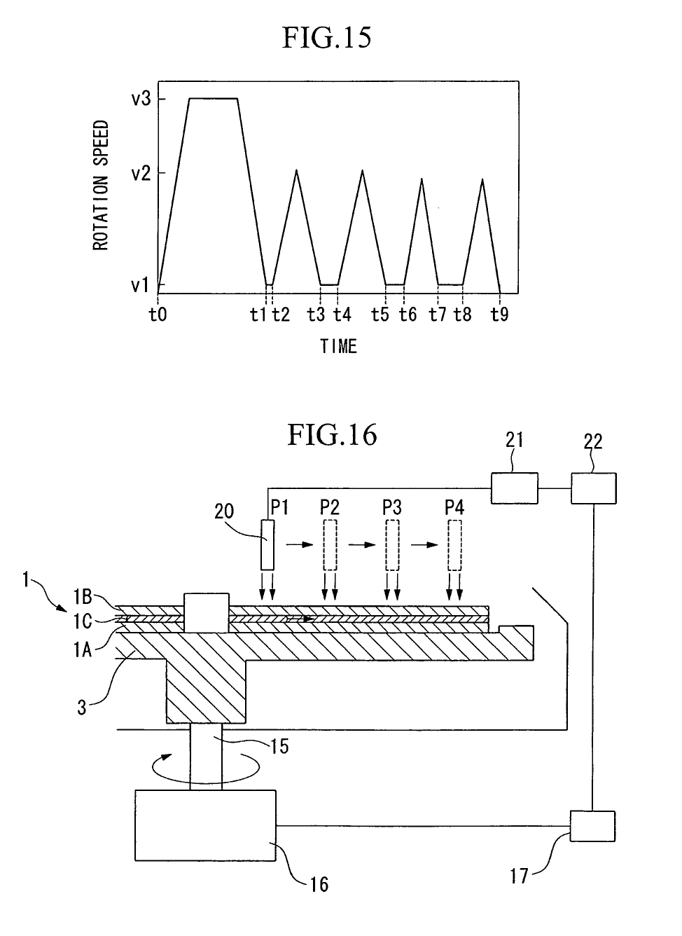

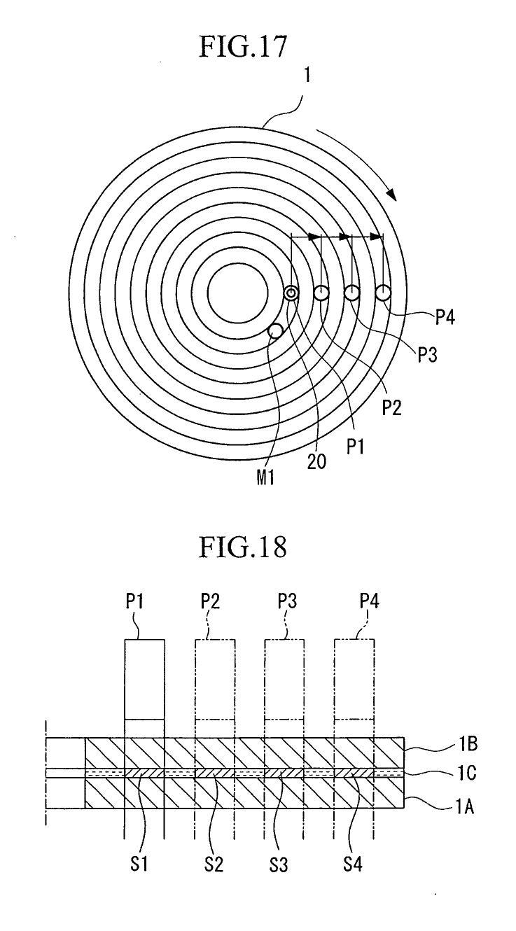

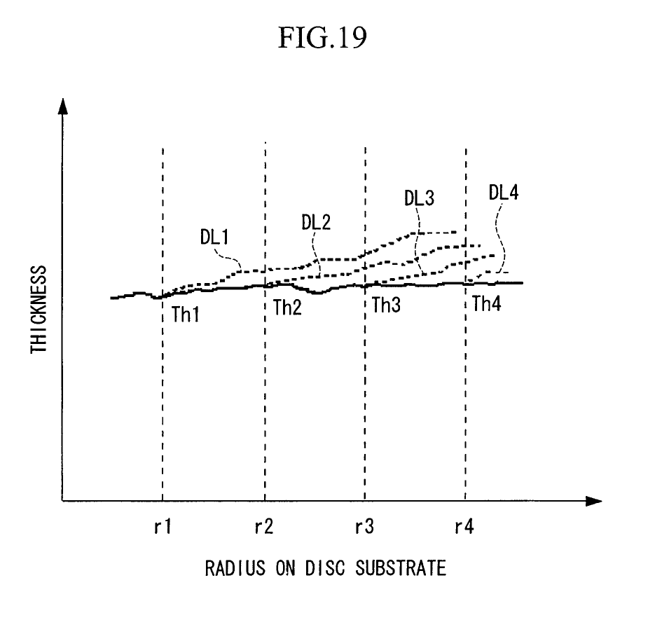

Next, referring to FIGS. 15-19, another embodiment is explained. The same reference numerals used in the above-described embodiment indicate similar members. FIG. 15 shows a rotation speed control program of this embodiment, and FIG. 16 shows a cross-sectional view of an apparatus. FIG. 17 and FIG. 18 show changes of light radiation position P1-P4. FIG. 19 shows a relationship between positions on the substrate of this embodiment in a radial direction and the thickness of a resin layer.

In FIG. 16, on the substrate receiving base 3, the substrate 1 constituted from the substrate 1A and the substrate 1B which are adhered by the adhesive 1C is mounted so as to set a side of the substrate 1B upward. Above the substrate 1, an optical fiber 20 is vertically or perpendicularly arranged, and the ultraviolet ray supplied from an ultraviolet light source 21 is radiated in a spot shape on the adhesive 1C which is extended between the substrate 1A and substrate 1B. The radiation control apparatus 22 controls an on/off operation, a radiation time and radiation strength of ultraviolet ray by controlling the ultraviolet light source 21, and correspondingly conducts operations with the rotation control apparatus 17.

Next, operations are explained. First, the rotation starts from a time t0 of a spin program shown in FIG. 15, and is increased so as to be a rotation speed v3. The adhesive between the substrate 1A and the substrate 1B close to a center aperture is extended radially outward because of centrifugal force caused by the high speed rotation. After maintaining the rotation at the rotation speed v3 for a few seconds, the rotation speed is decreased to the rotation speed v1

At a time t1 at which the rotation speed is decreased to be v1, the ultraviolet ray supplied from the ultraviolet light source 21 is radiated by the optical fiber 20 which is arranged above a first position P1 (radius r1) on the inside edge of the substrate 1, and the ultraviolet ray continue radiating for a time t1-t2 along with rotating at the low rotation speed v1. The adhesive 1C (S1 in FIG. 18) of the first position P extended by the high speed rotation at the rotation speed v3 is semi-cured, and the layer thickness is adjusted so as to be Th1 as shown in FIG. 19. After the first high speed rotation, the layer thickness distribution which positions at the outside of the first position P1 is thick compared to the area position at the inside of P1 as shown with a dotted line DL1. By rotation at the low rotation speed which does not substantially extend the adhesive after reducing the rotation speed from the high rotation speed, effects of centrifugal force affecting the adhesive 1C is reduced; therefore, it is possible to reduce or get rid of an amount of the adhesive 1C extended radially outward while radiating ultraviolet ray. The rotation speed v1 of the low speed rotation is, as a concrete example, 100-600 rpm.

Next, by increasing the rotation speed from the low rotation speed v1 to a high rotation speed v2 at a time t2, the adhesive 1C is extended again. Moreover, at the time t2, the optical fiber 20 begins to move to a second position P2 (radius r2) in accordance with a control apparatus which is not shown in the figures. It is possible to move the optical fiber 20 to the second position P2 during the time t2-t3 which is the time of the high speed rotation. At this time, the adhesive 1C at a position facing the first position P1 is not extended because it is cured and it has no fluidity; therefore, the layer thickness Th1 is not changed and a portion of the adhesive 1C positions at the outside of the second position P2 is extended. Because of the second high speed rotation, the layer thickness shown with the dotted line DL2 drawn at the position of the radius r2 in FIG. 19 is reduced. After the high speed rotation of the substrate 1 at the rotation speed v2, the rotation speed is reduced to be the low rotation speed v1 again.

During the time t3-t4, the adhesive 1C spread at the second position P2 is semi-cured by slowly rotating at the rotation speed v1 and radiating the ultraviolet ray by using the optical fiber 20, and the layer thickness is adjusted so as to be Th2 as shown in FIG. 19. The circumference is longer along with moving radially outward from the center on the substrate; therefore, by setting the time t3-t4 longer than the time t1-t2, it is possible to effectively semi-cure the adhesive C1 at the second position P2 around the overall circle.

The high speed rotation and the low speed rotation are alternately repeated after the time t4 in such a manner, the adhesive 1C is extended so as to be a predetermined thickness upon rotating at the high speed, and the ultraviolet ray is radiated on the adhesive 1C of the areas S2-S4 in order to semi-cure upon rotating at a low speed; therefore, it is possible to achieve flat and even layer thickness overall such as the layer thickness Th1-Th4 shown in FIG. 19.

The substrate 1, on which the adhesive 1C is semi-cured by radiating ultraviolet light in a spot shape along with alternately repeating the high speed rotation and the low speed rotation, is moved to and mounted on another position which is not shown in drawings, and the ultraviolet ray is radiated over the entire substrate 1 in order to completely cure the adhesive 1C. In such a case, the adhesive 1C is semi-cured and polymerization has already started; therefore, it is possible to completely cure the adhesive 1C even by applying a small amount of radiation energy. Moreover, in this embodiment, the adhesive 1C is semi-cured in order to reduce fluidity of the adhesive 1C; however, it is possible to completely cure. In such a case, it is possible to omit a curing step in which the ultraviolet ray is radiated over the entire area of the substrate at another position.

It is possible that data of multiple radiation patterns (radiation width, radiation time, radiation suspension time, and the like) which is obtained based on various experiments conducted beforehand, and which can be applied to characteristics including for example, viscosity of the adhesive, and which is adaptable to surrounding and environmental conditions, be stored in the radiation control apparatus 22. Therefore, it is possible that an operator select the radiation pattern or input the characteristics of the adhesive and the radiation pattern appropriate for conditions so as to be automatically selected. Moreover, it is possible that the radiation time and the radiation suspension time be set in accordance with the high rotation speed time and the low rotation speed time of the selected rotation model at the rotation control apparatus 17.

It is possible that, as shown in FIG. 17, a layer thickness measuring unit M1 be arranged at a position facing the substrate 1 along with obtaining the same radial distance as the optical fiber 20, the layer thickness of the adhesive 1C extended by the high speed rotation be measured, and radiation of ultraviolet ray be controlled so as to start radiating just before the layer thickness reaches a predetermined and target thickness; therefore, a flat or even layer thickness is obtained without being affected by influences of both characteristics including for example viscosity of the adhesive and surrounding and environmental conditions.

Moreover, the high speed rotation at the rotation speed v3 is conducted at a first time and the high speed rotation at the rotation speed v2 which is lower than the rotation speed v3 is conducted at a second time or later in this embodiment, in other words, the adhesive applied at the inside edge is extended to approximately outside edge by the high speed rotation, and moreover, the layer thickness of the inside edge is arranged so as to be a predetermined thickness. While rotating at the second time or later at a speed slower than the first rotation speed, the layer thickness of the outside edge is gradually fixed. Moreover, it is possible to control the rotation speed in a manner in which the rotation speed upon rotating at the high speed is gradually reduced along with progress of the rotation from the first time high speed rotation to the second time rotation, to the third time rotation, and so on. By conducting such control of the rotation speed, it is possible to achieve flat or even layer thickness with high accuracy in a short time. It is possible to control by applying the same rotation speed to both the first rotation speed v3 and the second or later rotation speed v2. Moreover, it is possible that, as a radiation timing shown in FIG. 4, light be radiated when the rotation speed is reduced to be the low rotation speed VL or lower.

In this embodiment, the optical fiber 20 is moved in a radial direction from inside to outside of the substrate 1; however, it is possible to arrange several or multiple optical fibers 20 at predetermined positions in a radial direction from inside to outside, and in turn, to radiate from the inside. By applying such a constitution, moving time and a moving apparatus of the optical fiber 20 are not necessary; therefore, it is possible to shorten the operation time and to constitute the apparatus in a smaller size. Moreover, it is not necessary to move the optical fiber 20; therefore, it is possible to keep radiating after finishing radiation at a predetermined position on the substrate 1. In this case, it is possible to completely cure the adhesive 1C from a semi-cured state.

It is possible to apply a semiconductor light emission device instead of the optical fiber 20 in order to radiate an ultraviolet ray in a spot shape. Moreover, it is possible to partially radiate an ultraviolet ray by using a shutter as shown in FIG. 2 or FIG. 6. Furthermore, it is possible to radiate ultraviolet in a radial direction from inside to outside by reflecting an ultraviolet ray on a movable mirror and changing an angle, or by moving the movable mirror.

As described above, the high speed rotation and the low speed rotation are alternately repeated in this embodiment as well; therefore, the adhesive on a ring shape area of a certain width in a radially outward direction is extended so as to be a certain thickness and is semi-cured or cured. The predetermined thickness is fixed and influence of centrifugal force due to the high speed rotation afterward is prevented. Therefore, the adhesive layer of an even thickness overall is formed. Moreover, even if the radiation intensity of the ultraviolet light is small, by radiating upon rotating at the low rotation speed, it is possible to sufficiently semi-cure or cure, and to prevent a fluctuation of the layer thickness so as to be minimum.

In the above-described embodiment, forming steps of the adhesive between two substrates are explained; however, the concept of the embodiments can be applied in the same manner to a case in which, without adhering the substrates, the liquid material supplied on an inside of one substrate is extended overall in a radial direction from inside to outside, and the covering layer with an even or flat thickness is formed. Especially it is effective for forming a light transmission protective layer of the next generation large volume optical disc.

The light emission member 18 such as the light emission diode, the plasma unit, and the like radiates light with a smaller amount of light intensity compared to a lamp which emits ultraviolet rays such as a normal discharge lamp, xenon lamp, and the like; however, generated heat is incomparably smaller; therefore, there are small effects on the substrate, and it is possible to adjust a distance between the light emission surface H and the substrate 1 greatly smaller than a case of using a lamp. Therefore, it is possible to semi-cure the liquid material in a comparatively short time by using the light emission member 18.

Moreover, it is possible to use a liquid crystal shutter which is obtained by applying liquid crystal technology instead of the mechanical shutter of the above-described embodiment. In other words, the liquid crystal shutter is provided between the radiation lamp and the substrate, electric signals are applied to the liquid crystal, and light is sequentially increased in a radial direction from inside to outside; therefore, the adhesive between the substrates of the resin on the substrate is semi-cured so as to be a predetermined thickness. If the liquid crystal shutter is applied, it is possible to improve the operational speed.

In the above-described embodiment, it is possible that a thickness sensor which is not shown in the figures be applied, the layer thickness be continuously or sequentially detected radially outward from the center, the measured layer thickness be compared with a predetermined layer thickness, and the ultraviolet ray be radiated on a portion of the adhesive at which the measured layer thickness is the same as a predetermined layer thickness in order to semi-cure or cure. The thickness sensor has the same function as a laser displacement gauge. Below, a measurement principle of the laser displacement gauge is briefly explained. The measurement principle is a method to which a triangular survey is applied, and has a constitution in which a light emission device and a light receiving device are combined. A semiconductor laser is applied as the light emission device. A laser generated by the semiconductor laser is integrated via a projection lens, and is radiated on the adhesive layer via the substrate. Also, a portion of the reflected light from the adhesive layer forms a spot on the light receiving device via the lens. If the thickness of the adhesive layer has changes or differences, an incidence angle of the reflected light which comes into the light receiving device of the thickness sensor fluctuates or changes; therefore, it is possible to detect the thickness of the substrate and the adhesive layer. The thickness of the substrate is already known; therefore, it is possible to momentarily detect the thickness of the adhesive layer by compensating, correcting or calculating based on the thickness of the substrate.

It should be noted that the same effects can be obtained by using a CCD as well. Moreover, this is not shown in the figures; however, by using a CCD sensor in a bar-shape on which the CCD devices are spread in a range almost the same as a radius of the substrate 1, it is possible to detect the thickness based on an intensity of the reflected light.

In the explanations above, for simplification, there was an explanation in which the light emission moves at a fixed speed in a direction from inside to outside, and the entire radiation time and the entire radiation suspension time is fixed and repeated; however, an inside edge portion has large differences of thickness, and an outside edge portion has comparatively large differences of thickness; therefore, it is possible to conduct the above-described steps so as to be less than the average thickness.

In the embodiments, the liquid material is continuously or sequentially semi-cured or cured along with extending the liquid material by the spinner; therefore, there is no such case seen in the prior art, in which two substrates are slightly slipped off when the substrates are transported to the next step by a transportation means not shown in the figures; and therefore, it is possible to obtain an optical disc of higher quality.

Moreover, with respect to an especial liquid material which is appropriate for applying to the embodiments, the liquid material which is cured by using an ultraviolet ray and which is currently sold on the market is obtained by annexing a photoinitiator to some extent so as not to start curing while operating in a normal condition. However, the light emission diode, the liquid crystal means, the plasma means, and the like have lower luminous intensity of ultraviolet rays than a flush lamp or a discharge lamp; therefore, it is preferable to increase the photoinitiator in order to increase sensitivity to ultraviolet rays in a range in which there is no influence on optical characteristics, mechanical characteristics or storage characteristics.

On the other hand, if the photoinitiator which is added to the liquid material is increased in order to largely gain sensitivity to ultraviolet rays, it is impossible to use under a conventional environment. In this case, it is preferable that a red light emission diode or a yellow light emission diode be used as a lighting equipment, or it is possible that, for example, a wavelength selective filter which blocks wavelength of 300-420 μm and a lamp be combined and be used as a lighting equipment.

In such a manner, by using the diode for emitting ultraviolet rays as a hardening apparatus of the liquid material sensitized to ultraviolet rays, and by using the red light emission diode, the plasma unit, the liquid crystal unit, or the like as the lighting equipment in which the adhesive is delta, it is possible to greatly reduce electric charge, it is very preferable from an environmental viewpoint, and moreover, it is possible to reduce the cost.

In the above-described embodiments, the mechanical shutter is used together with the radiation lamp. It is possible to use a lamp as the radiation lamp which radiates ultraviolet rays that extend in a ring shape in accordance with the distance and to arrange the lamp right above the central aperture of the substrate; therefore, it is possible to move the radiation of ultraviolet rays in a radial direction from inside to outside of the substrate by gradually or intermittently moving the lamp upward corresponding to the extension of the adhesive caused by the high speed rotation of the substrate. Therefore, it is possible to omit the mechanical shutter.

Moreover, it is possible to use a lamp as the radiation lamp which can, for example, form an ultraviolet spot of approximately 10 mm diameter on the substrate 1. Therefore, by moving the ultraviolet spot from inside to outside, it is possible to continuously or gradually radiate the ultraviolet spot in a radial direction from inside to outside along circles of different diameters on the rotating substrate. Therefore, it is possible to omit the mechanical shutter, it is advantageous from viewpoints of cost and downsizing, and it is easy to conduct the mounting operation of the substrate to the spinner.

Moreover, in the embodiment shown in FIG. 9, the mechanical shutter was cooled down by using cooling air from horizontal direction of the figure. On the other hand, there is a cooling mechanism of the radiation lamp in which the cooling air is made to flow from the upper area of the lamp, and it is possible to use this cooling air from the upper area for cooling the mechanical shutter. In this case, it is not needed to separately or independently provide the cooling mechanism for the mechanical shutter, and it is possible to provide a heat-resistant glass plate between the spinner and the mechanical shutter if the air blown on the substrate 1 from the upper area via the radiation aperture of the mechanical shutter causes undesirable effects.

By using the light emission diode, the plasma display panel, and the like as a light emitting unit, it is possible to greatly reduce electric charge, it is very preferable from an environmental viewpoint, and moreover, it is possible to reduce the cost.

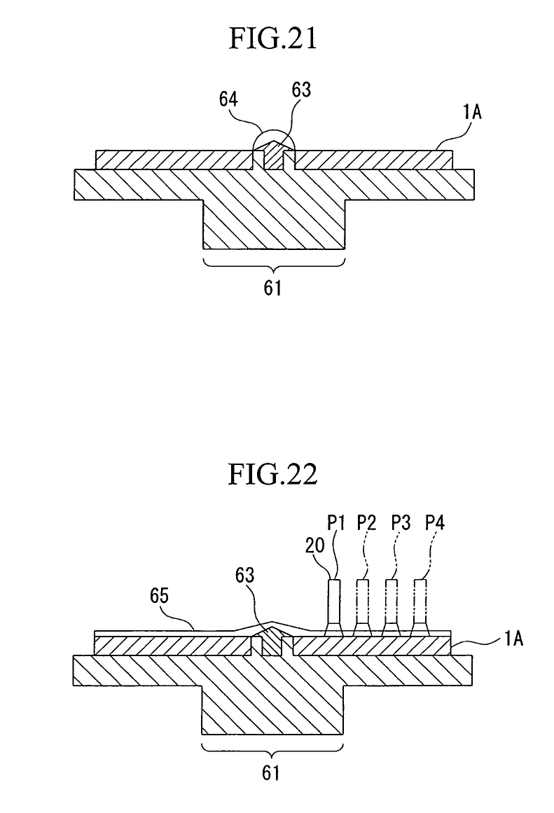

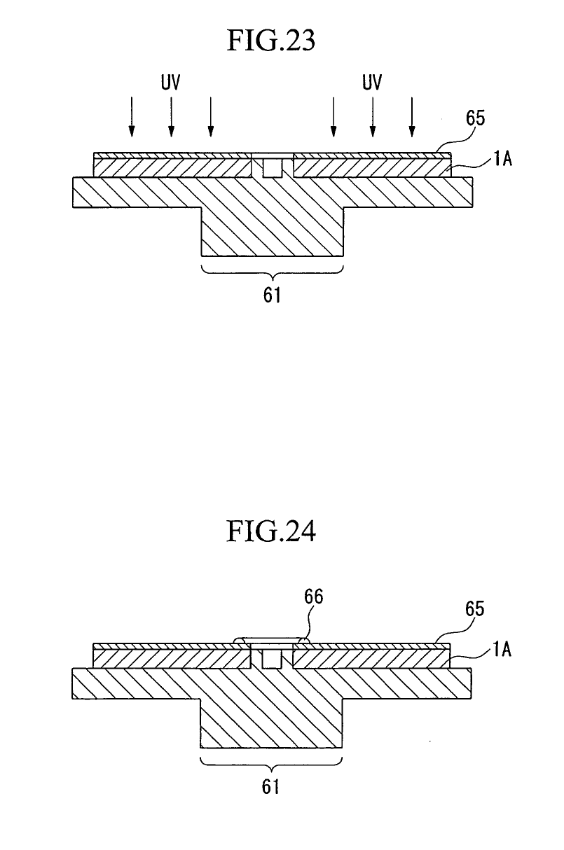

FIG. 21-25 shows an embodiment in which the adhesive layer is formed in two coating steps. In this embodiment, at the center of a substrate receiving base 61, a cap 63 in a circular cone shape which protrudes upward is coaxially and detachably attached. After mounting the substrate 1A on the substrate receiving base 61, a first adhesive 64 is put on the cap 63. Next, the substrate receiving base 61 is rotated in a manner the same as the above-described embodiments by alternately repeating the high and low speed rotation, the position of the optical fiber 20 is gradually moved outside such as P1→P2→P3→P4, and radiation is conducted by using the optical fiber 20 at the points P1-P4 upon rotating at a low speed. Therefore, it is possible to form an even or flat coating or film 65.

Next, after removing the cap 63, an ultraviolet ray is radiated on an overall surface of the substrate 1A, the coating is hardened or cured, and a resin layer 65 is obtained.

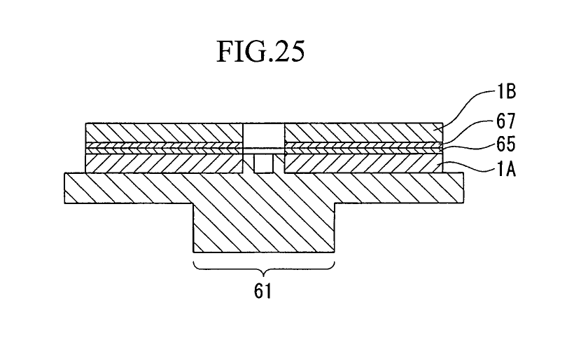

Next, as shown in FIG. 24, a second adhesive 66 is supplied on the inside of the resin layer 65 so as to be coaxial to the substrate 1A, and moreover, as shown in FIG. 25, the substrate 1B is set on the substrate 1A so as to be overlapped. The amount of the second resin can be much smaller than the first resin because it is sufficient if an adhesive strength obtained. It is possible to apply the same adhesive or different adhesive to the first adhesive and the second adhesive.

Next, the substrate 1 which is laminated or stacked (1A+65+the second adhesive layer 67+1B) is rotated at a high speed, the excess second adhesive is shaken off, and the second adhesive layer 67 is formed which has sufficient thickness for adhering the substrates 1A and 1B. The second adhesive layer 67 is cured or hardened by radiating ultraviolet rays on an overall surface of the laminated or stacked substrate 1 obtained in accordance with the above-described steps, and the disc is obtained.

In accordance with this embodiment, the first adhesive layer 65 which is a large portion of the adhesive for adhering the substrates 1A and 1B is gradually cured or hardened and is formed to be a uniform/even thickness, and on the other hand, the thin second adhesive layer 67 is formed only by rotation at a high speed; therefore, it is possible to obtain the adhesive layer (65+67) of a substantially uniform or even thickness. Moreover, it is possible to spread, coat or apply the adhesive by using the cap 63.

It should be noted that, other than an object to arrange the layer thickness to be uniform or even, by applying the present invention, it is possible that, for example, the resin layer be formed so as to obtain a predetermined profile of the layer thickness in a radial direction outward from the center.

In accordance with the present invention, along with gradually extending the liquid material, when the liquid materials approximately a predetermined thickness, the liquid material is cured or semi-cured and the thickness is fixed; therefore, it is possible to an achieve even or uniform thickness of the liquid material spread on the overall surface of the substrate along with preventing further extension because of centrifugal force caused by the high speed rotation afterward.

What is claimed is:

1. A resin layer forming method which is characterized by comprising:
a step of supplying liquid material at an inside edge portion of a substrate;
a step of alternately conducting both a step of extending the liquid material by rotating the substrate at a high speed and a step of rotating the substrate at a low speed which is lower than the high speed;
a step of radiating during a time of rotating at the low speed by gradually or intermittently moving a radiation area radially outward form inside and semi-curing or curing the liquid material from inside to outside of the substrate.

2. A resin layer forming method according to claim 1, wherein the time of rotating at a low speed is the time necessary for semi-curing or curing the liquid material.

3. A resin layer forming method according to claim 1, wherein the low speed is a speed which causes centrifugal force that substantially does not extend the liquid material.

4. A resin layer forming method according to claim 1, wherein:
the liquid material is an adhesive which is supplied between clear first and second substrates; and
the adhesive forms an adhesive layer of a substantially uniform or even thickness by being radiated through the substrate.

5. A resin layer forming method according to claim 1, wherein the liquid material is constituted from a clear synthetic resinous material and forms a light transmission protective layer of approximately uniform thickness.

6. A resin layer forming method according to claim 1, wherein radiation is continuously or intermediately conducted on portions which have a predetermined thickness due to being extended by rotation at a high speed, in order to gradually fix the predetermined thickness radially outward from inside.

7. A resin layer forming method according to claim 1, wherein:
data is obtained beforehand based on parameters of at least both rotation speeds and characteristics including viscosity of the liquid material in order to set the liquid material to a predetermined thickness; and
a radiation timing is determined based on the data in order to form the resin layer of an approximately uniform thickness.

8. A resin layer forming method according to claim 1, wherein, in the step of extending the liquid material by rotating the substrate at a high speed, a thickness of the liquid materiel which is extended is detected, and the radiation is conducted on a portion which has a predetermined thickness when the portion reaches the predetermined thickness.

9. A resin layer forming method according to claim 1, wherein the radiation is conducted on an overall surface of the resin layer after forming the resin layer from the liquid material in order to form the resin layer of a uniform thickness.

10. A resin layer forming apparatus which is characterized by comprising:
a spinner which extends liquid material supplied to a substrate by rotation at a high speed;
a rotation control apparatus which controls a rotation speed of the spinner; and
a selective radiation unit which gradually moves the radiation position in a radial direction from inside to outside while the liquid material is extended by the spinner, wherein:
the rotation of the spinner is alternately and repeatedly conducted at a high speed and a low speed;
the radiation is conducted upon rotating at the low speed; and
the liquid material is semi-cured or cured in a radial direction from inside to outside.

11. A resin layer forming apparatus according to claim 10, wherein the selective radiation unit comprises:
an emission unit; and
a mechanical shutter which continuously or intermittently opens a center aperture, wherein
a radiated area on the substrate radiated by the emission unit is extended while opening the center aperture.

12. A resin layer forming apparatus according to claim 10, wherein:
the selective radiation unit is an emission lamp which comprises a plurality of semiconductor emission devices concentrically arranged on a plurality of rings; and
the semiconductor emission devices continuously and gradually radiates in a radial direction from inside to outside.

13. A resin layer forming apparatus according to claim 10, wherein:
the selective radiation unit is an emission unit which is arranged at a position facing the center aperture of the substrate and which moves in a substantially vertical direction against a surface of the substrate; and
the selective radiation unit moves away from the substrate while the liquid material is extended by rotating the substrate.

14. A resin layer forming apparatus according to claim 10, wherein:
the selective radiation unit is an emission unit which radiates in a spot shape; and
the selective radiation unit moves the spot in a radial direction from inside to outside on the substrate while the liquid material is extended by rotating the substrate.

15. A resin layer forming apparatus which is characterized by comprising:
a spinner which extends liquid material supplied to a substrate by rotation at a high speed;
a rotation control apparatus which controls the rotation speed of the spinner; and
a radiation unit which gradually moves the radiation position in a radial direction from inside to outside while the liquid material is extended by the spinner, wherein:
the rotation of the spinner is alternately and repeatedly conducted at a high speed and a low speed;
the radiation is conducted upon rotating at the low speed; and
the liquid material is semi-cured or cured in a radial direction from inside to outside.

16. A resin layer forming apparatus according to claim 15, wherein:
the radiation unit is an emission unit which radiates in a spot shape; and
the radiation unit moves the spot in a radial direction from inside to outside on the substrate while the liquid material is extended by rotating the substrate.
